(19) United States
(12) Patent Application Publication
(10) Pub. No.: US 2018/0173258 A1
(43) Pub. Date: Jun. 21, 2018

(54) VOLTAGE REGULATOR WITH FAST TRANSIENT RESPONSE

(71) Applicant: Qorvo US, Inc., Greensboro, NC (US)

(72) Inventor: Gaurav Singh, Eindhoven (NL)

(21) Appl. No.: 15/847,858

(22) Filed: Dec. 19, 2017

Related U.S. Application Data
(60) Provisional application No. 62/435,975, filed on Dec. 19, 2016.

(51) Int. Cl. G05F 1/46; G05F 1/575

(52) U.S. Cl. CPC G05F 1/461; G05F 1/575

(57) ABSTRACT

Voltage regulators with fast transient response are provided herein. According to one aspect, a voltage regulator for accepting an input voltage (V_{REF}) and producing an output voltage (V_{OUT}) comprises an operational amplifier having as a first input (V_{REF}) and having as a second input a feedback voltage (V_{FB}); an output amplifier having an input coupled to the output of the operational amplifier and an output that produces V_{OUT}, the output being coupled to a feedback path that produces V_{FB}; a compensation capacitor (Cc) connected between the output of the output amplifier and an input to a buffer amplifier that supplies a voltage to the input of the output amplifier. The buffer amplifier has a transconductance (gm_{BUF}) that is controlled to be proportional to a load current (I_{LOAD}), thereby causing the left hand plane zero of the buffer amplifier to cancel the pole created by the output amplifier.

### RELATED APPLICATIONS

This application claims the benefit of provisional patent application Ser. No. 62/435,975, filed Dec. 19, 2016, the disclosure of which is hereby incorporated herein by reference in its entirety.

### FIELD OF THE DISCLOSURE

Embodiments of the present disclosure relate generally to the field of circuits, and more particularly to a voltage regulator circuit.

### BACKGROUND

Voltage regulators accept an input voltage (V_{IN}) and produce a regulated output voltage (V_{OUT}). In an ideal voltage regulator, the desired V_{OUT} will be output by the regulator, so long as V_{IN} is greater than or equal to V_{OUT}. In real circuits, however, there is some voltage drop across the regulator—i.e., between V_{IN} and V_{OUT}—and so V_{IN} must be greater than V_{OUT} by at least this voltage drop. The minimum voltage required across the regulator to maintain regulation is referred to as the “dropout voltage.” Thus, in order for a voltage regulator having a dropout voltage of V_{DO} to provide an output voltage of V_{OUT}, V_{IN} must be at least V_{OUT}+V_{DO}.

A Low-Dropout Voltage Regulator (which may be referred to herein as “an LDO voltage regulator,” “an LDO regulator,” or simply “an LDO”) is one that can regulate the output voltage even when the supply voltage is very close to the output voltage: when V_{DO} is small, V_{IN} can be very close to V_{OUT} and the regulator will still operate correctly.

FIG. 1 is a circuit schematic of a conventional LDO voltage regulator 10. A typical LDO 10 uses an operational amplifier, or “op amp,” 12 to drive the control terminal of a Bipolar Junction Transistor (BJT) or Field-Effect Transistor (FET) device 14. Thus, a generic LDO 10 can be considered to be a two-stage amplifier consisting of a so-called Error Amplifier (EA) stage and an output (OUT) stage. In complementary Metal Oxide Semiconductor (MOS) process, the output stage is usually a MOS transistor, the impedance of which is controlled by the feedback loop in order to regulate the voltage at its drain. Therefore, such a regulator can be considered to be a two-stage voltage feedback amplifier.

In the conventional LDO 10 illustrated in FIG. 1, the op amp 12 may also be referred to as the error amp 12, and has a transconductance value (gm_{EA}), while the FET 14 may also be referred to as the output amp 14, and has a transconductance value (gm_{OUT}). The amplifier feedback signal (A_{FB}) is provided by a voltage divider 16, comprising a resistor ladder with resistors R1 and R2 connected in series to provide a feedback voltage (V_{FB}) to one of the input terminals of the op amp 12. The op amp 12 has an output resistance represented in FIG. 1 as a shunt resistance (Ro_{EA}). The load at the output of the LDO 10 is represented in FIG. 1 by a load resistance R_{LOAD} and an output capacitance (C_{OUT}). A reference voltage (V_{REF}) is provided as the input to the LDO 10 and is connected to another of the input terminals of the op amp 12

The transfer function of such a system usually includes two poles: a first pole at the output of the first amplifier stage (P1) and a second pole at the output of the second stage (P2). In the absence of compensation, these two poles are not greatly separated in frequency; thus, some compensation is needed to stabilize the system. Further, the location of the output pole (P2) in a voltage regulator is directly proportional to the load current. A typical LDO 10 is required to support a large dynamic range of load currents, which creates an additional challenge in stabilizing the system. See Equations (1) and (2).

$$\begin{matrix}{R}_{LOAD} = \frac{{V}_{OUT}}{{I}_{LOAD}} & EQ . ( 1 ) \\ P 2 = \frac{1}{{R}_{LOAD} {C}_{out}} ∝ \frac{{I}_{load}}{{C}_{out}} & EQ . ( 2 )\end{matrix}$$

where V_{OUT} is the output voltage of the LDO 10 and I_{LOAD} is the load current at the output terminal.

Several solutions have been disclosed in the past to stabilize a LDO 10. One form of compensation is called Miller compensation and involves placing a compensation capacitor (Cc) across the output stage (e.g., the FET 14) of the LDO 10. This compensation capacitor splits the two poles, whereby the dominant pole at P1 is moved to a lower frequency, and the pole at the output (P2) is moved to a higher frequency, thereby stabilizing the system. This is shown in FIG. 2.

FIG. 2 is a graph of the frequency response of the conventional LDO with Miller compensation. A well-known issue with Miller compensation, however, is that the compensation capacitor (Cc) creates a zero in the Right Half Plane (RHP), which may reduce stability.

FIG. 3 is a circuit schematic of a conventional Miller-compensated LDO 18 that uses a nulling resistor (R_{Z}) in series with the compensation capacitor (Cc) to solve the RHP zero problem. To support a large dynamic range of load currents, the compensation capacitor (Cc) must be chosen to be large enough for the system to be stable for the lowest load current. This has a negative effect on the bandwidth and transient response of the conventional Miller-compensated LDO 18.

FIG. 4 is a circuit schematic of a conventional Miller-compensated LDO 20 that uses a current buffer 22 in series with the compensation capacitor (Cc) to solve the RHP zero problem in a more robust way. This current buffer 22 eliminates the forward path and hence the RHP zero as shown in FIG. 4. A common implementation of such a circuit is also called “Ahuja compensation” or “cascode compensation”. Another advantage of this compensation technique is that it introduces a Left Half Plane (LHP) zero, which further helps in stabilizing the system. See also Equation (3).

$${LHP}_{zero} = - \frac{{gm}_{CG}}{{C}_{c}} \qquad EQ . ( 3 )$$

where gm_{CG} is the transconductance of the P-Type MOS (PMOS) transistor that connects the output of the error amplifier 12 to the compensation capacitor having a capacitance value (Cc). FIG. 4 also shows the equivalent circuit of the current buffer 22 and compensation capacitor (Cc): the current buffer 22 operates as a resistor to ground having an impedance of 1/gm_{CG}. The frequency of the zero introduced by the current buffer 22 is a function of the values of the transconductance (gm_{CG}) and the capacitance (Cc).

FIG. 5 is a circuit schematic of a conventional Miller-compensated LDO 24 that uses another method for solving the RHP zero issue in Miller compensation, which is to use the so-called split-length MOS compensation. In this approach, an error amplifier 26 includes a low-impedance node created by splitting a MOS transistor—for instance, one of the input MOS pair of a conventional op amp—and placing each part in series. In FIG. 5, one of the pair of input MOS transistors has been split into two MOS transistors connected in series, Mn_{1A} and Mn_{1B}, while the other of the pair of input MOS transistors has been split into another two MOS transistors connected in series, Mn_{2A} and Mn_{2B}. For each set of series connected MOS transistors, the gates of the two series-connected MOS transistors are connected together. As a result, the MOS transistor placed at the source side (Mn_{2B}) is in triode mode and has a transconductance of gm; its impedance can be approximated to 1/gm. The MOS transistor (Mn_{2A}) operates as a buffer amplifier 28 and has a transconductance of gm_{BUF}.

The compensation capacitor (Cc) is placed at the low-impedance node between the two MOS transistors in series, e.g., between Mn_{2A} and Mn_{2B} in FIG. 5. This splitting of MOS transistors results in effectively nulling the RHP zero and introducing a LHP zero, which is at a frequency proportional to gm_{BUF}/C_{c}.

The cascode compensation (Ahuja compensation) and split-length MOS compensation techniques are sometimes grouped together and referred to as indirect Miller compensation. They are referred to as such in the remainder of the present disclosure.

FIG. 6 represents a general indirect Miller-compensated LDO 30 that contains the error amplifier 26, the output amplifier 14, and the buffer amplifier 28. The amplitude of the feedback signal will be some fraction of the output voltage (V_{OUT}); this is represented in FIG. 6 by voltage divider 16, which may represent a resistor ladder or other circuit that provides a feedback signal with amplitude (V_{OUT}/M). Each amplifier drawn can consist of one or more stages. As discussed previously, this system has two main poles: P1 at the output of the first amplifier stage and P2 at the output of the second amplifier stage.

However, the output pole (P2) of this system varies with load current, and because of this, the dominant pole (P1) needs to be at a relatively low frequency in order to avoid instability in the LDO 30. In addition, the transconductance of the buffer amplifier 28, gm_{BUF}, introduces a LHP zero that is located at gm_{BF}/C_{c}. See also Equations (4) to (6).

$$\begin{matrix}P 1 ∝ \frac{{Rout}_{EA}}{{A}_{OUT} Cc} & EQ . ( 4 ) \\ P 2 ∝ \frac{{I}_{LOAD}}{Cc} & EQ . ( 5 ) \\ {LHP}_{zero} = - \frac{{gm}_{BUF}}{{C}_{c}} & EQ . ( 6 )\end{matrix}$$

where Rout_{EA} is the output resistance of the error amplifier 26, A_{OUT} is the gain of the output amplifier 14, and (Cc) is the value of the compensation capacitor.

In summary, Miller compensation and its variants have a fundamental drawback in terms of limitation placed on the bandwidth of the system: because the output pole varies with load, the dominant pole has to be at a lower frequency than desired. This affects both the wideband power supply rejection ratio and transient response of the LDO, where stability needs to be ensured for a wide dynamic range of load currents.

### SUMMARY

The present disclosure relates to a voltage regulator, specifically a LDO designed for fast transient response and a high power supply rejection ratio across a wide frequency bandwidth while consuming low quiescent current. This is achieved by using an improved compensation technique for stabilizing the LDO. The compensation technique of the present disclosure eliminates the restriction on amplifier bandwidth imposed by the traditional Miller compensation and is suitable for application in a voltage regulator in which the output pole varies inversely proportionally to the load currents.

According to one aspect of the present disclosure, a voltage regulator for accepting an input voltage (V_{REF}) and producing an output voltage (V_{OUT}) comprises: an operational amplifier having a first input, a second input, and an output, the first input accepting the input voltage (V_{REF}); an output amplifier having an input coupled to the output of the operational amplifier and an output that produces V_{OUT}, the output being coupled to a feedback path that produces a feedback voltage (V_{FB}) that is applied to the second input of the operational amplifier; a compensation capacitor (Cc) having a first terminal and a second terminal, the first terminal coupled to the output of the output amplifier; and a buffer amplifier having an input coupled to the second terminal of the compensation capacitor (Cc), and having an output coupled to the input of the output amplifier, the buffer amplifier having a transconductance (gm_{BUF}) that is controlled to be proportional to a load current (I_{LOAD}).

In some embodiments, gm_{BUF} is proportional to a bias current I_{BIAS} being supplied to the buffer amplifier and I_{BIAS} being supplied to the buffer amplifier is proportional to a load current (I_{LOAD}).

In some embodiments, the operational amplifier introduces a first pole (P1), the output amplifier introduces a second pole (P2), the buffer amplifier introduces a left hand plane zero (LHP_{ZERO}), and the transconductance (gm_{BUF}) is controlled such that LHP_{ZERO} cancels P2.

In some embodiments,

$${gm}_{BUF} = \frac{2 * {I}_{bias}}{{V}_{gs} - {V}_{t}}$$

and I_{BIAS} is controlled such that LHP_{ZERO} cancels P2.

In some embodiments, I_{BIAS} is provided according to the equation

$${I}_{bias} = \frac{( {V}_{gs} - {V}_{t} )}{2 {V}_{out}} {I}_{LOAD} .$$

According to another aspect of the present disclosure, a voltage regulator for accepting an input voltage (V_{REF}) and producing an output voltage (V_{OUT}) comprises: a PMOS transistor (M1) having a source, drain, and gate, the source being coupled to a first supply (V_{SUPPLY}); a PMOS transistor (M2) having a source, drain, and gate, the source coupled to (V_{SUPPLY}) and the gate being coupled to the gate of M1; a first current source having a first terminal and a second terminal, the second terminal being coupled to ground, the first current source providing a bias current (I_{BIAS}); an N-Type MOS (NMOS) transistor (Mn_{1A}) having a source, drain, and gate, the drain being coupled to the drain of M1 and the gate being provided with a voltage (V_{FB}); an NMOS transistor (Mn_{1B}) having a source, drain, and gate, the drain being coupled to the source of Mn_{1A}, the gate being provided with the voltage (V_{FB}), and the source being coupled to the first terminal of the first current source; an NMOS transistor (Mn₂) having a source, drain, and gate, the drain being coupled to the drain of M2 and the gate being provided with the voltage (V_{REF}); an NMOS transistor (Mn_{2B}) having a source, drain, and gate, the drain being coupled to the source of Mn_{2A}, the gate being provided with the voltage (V_{REF}), and the source being coupled to the first terminal of the first current source; a PMOS transistor (M_{OUT}) having a source, drain, and gate, the source being coupled to V_{SUPPLY}, the gate being coupled to the drain of M2, and the drain being coupled to an output terminal for producing V_{OUT}; a second current source having a first terminal and a second terminal, the first terminal being coupled to the output terminal and the second terminal being coupled to ground, the second current source providing a load current (I_{LOAD}); a compensation capacitor (Cc) having a first terminal being coupled to the output terminal and a second terminal being coupled to the drain of Mn_{2B}; and a feedback circuit having an input terminal coupled to the output terminal and an output terminal that produces V_{FB}; wherein I_{BIAS} is proportional to I_{LOAD}.

In some embodiments,

$${I}_{bias} = \frac{( {V}_{gs} - {V}_{t} )}{2 {V}_{out}} {I}_{LOAD} ,$$

wherein V_{gs} is the gate-source voltage of transistors Mn_{1A} and Mn_{2A} and Vₜ is the threshold voltage of transistors Mn_{1A} and Mn_{2A}.

In some embodiments, I_{BIAS} is proportional to I_{LOAD} according to the equation I_{bias}=k*I_{LOAD}.

In some embodiments,

$$k = \frac{2 * {I}_{bias}}{{I}_{load}} .$$

In some embodiments,

$$k = \frac{( {V}_{gs} - {V}_{t} )}{{V}_{out}} ,$$

wherein V_{gs} is the gate-source voltage of transistors Mn_{1A} and Mn_{2A} and Vₜ is the threshold voltage of transistors Mn_{1A} and Mn_{2A}.

According to yet another aspect of the present disclosure, a voltage regulator for accepting an input voltage V_{REF} and producing an output voltage V_{OUT} comprises: a PMOS transistor M1 having a source, drain, and gate, the source being coupled to a first supply V_{SUPPLY}; a PMOS transistor M2 having a source, drain, and gate, the source coupled to V_{SUPPLY} and the gate being coupled to the gate of M1; a first current source having a first terminal and a second terminal, the second terminal being coupled to ground; an NMOS transistor M3 having a source, drain, and gate, the drain being coupled to the drain of M1 and the gate being provided with a voltage V_{BIAS}; an NMOS transistor M4 having a source, drain, and gate, the drain being coupled to the drain of M2 and the gate being provided with the voltage V_{BIAS}; an NMOS transistor Mn₁₂ having a source, drain, and gate, the drain being coupled to the drain of M1, the gate being provided with a voltage V_{FB}, and the source being coupled to the first terminal of the first current source; an NMOS transistor Mn₂₂ having a source, drain, and gate, the drain being coupled to the drain of M2, the gate being provided with the voltage V_{REF}, and the source being coupled to the first terminal of the first current source; a second current source having a first terminal and a second terminal, the first terminal being coupled to the source of M3 and the second terminal being coupled to ground; a third current source having a first terminal and a second terminal, the first terminal being coupled to the source of M4 and the second terminal being coupled to ground; a PMOS transistor M_{OUT} having a source, drain, and gate, the source being coupled to V_{SUPPLY}, the gate being coupled to the drain of M2, and the drain being coupled to an output terminal for producing V_{OUT}; a fourth current source having a first terminal and a second terminal, the first terminal being coupled to the output terminal and the second terminal being coupled to ground, the fourth current source providing a load current I_{LOAD}; a compensation capacitor (Cc) having a first terminal being coupled to the output terminal and a second terminal being coupled to the drain of Mn_{2B}; a feedback circuit having an input terminal coupled to the output terminal and an output terminal that produces V_{FB}; wherein the current produced by each of the first, second, and third current sources is proportional to I_{LOAD}.

In some embodiments, the current produced by first current source is n*I_{LOAD}, the current produced by the second current source is m*I_{LOAD}, and the current produced by the third current source is m*I_{LOAD}, where n is different from m.

In some embodiments,

$$n = \frac{( {V}_{gs} - {V}_{t} )}{{V}_{out}} ,$$

wherein V_{gs} is the gate-source voltage of transistors Mn₁₂ and Mn₂₂ and Vₜ is the threshold voltage of transistors Mn₁₂ and Mn₂₂.

In some embodiments,

$$m = \frac{( {V}_{gs} - {V}_{t} )}{2 {V}_{out}} ,$$

wherein V_{gs} is the gate-source voltage of transistors M3 and M4 and Vₜ is the threshold voltage of transistors M3 and M4.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a circuit schematic of a conventional LDO voltage regulator with Miller compensation.

FIG. 2 is a graph of the frequency response of the conventional LDO showing load-dependent movement of P2.

FIG. 3 is a circuit schematic showing a conventional Miller-compensated LDO with a nulling resistor.

FIG. 4 is a circuit schematic showing a conventional Miller-compensated LDO with a current buffer (Ahuja compensation).

FIG. 5 is a circuit schematic showing a conventional Miller-compensated LDO with split-length MOS compensation.

FIG. 6 is a simplified circuit schematic of a conventional LDO with indirect Miller compensation.

FIG. 7 is a circuit schematic showing an exemplary LDO voltage regulator having improved compensation according to one embodiment of the present disclosure.

FIG. 8 is a graph of the frequency response of the exemplary LDO voltage regulator according to one embodiment of the present disclosure.

FIG. 9 is a circuit schematic showing one embodiment of the technique of the present disclosure using split-length MOS compensation.

FIG. 10 is a circuit schematic showing another embodiment of the present disclosure using adaptively biased cascode compensation.

FIG. 11 is a circuit schematic showing another embodiment of the present disclosure.

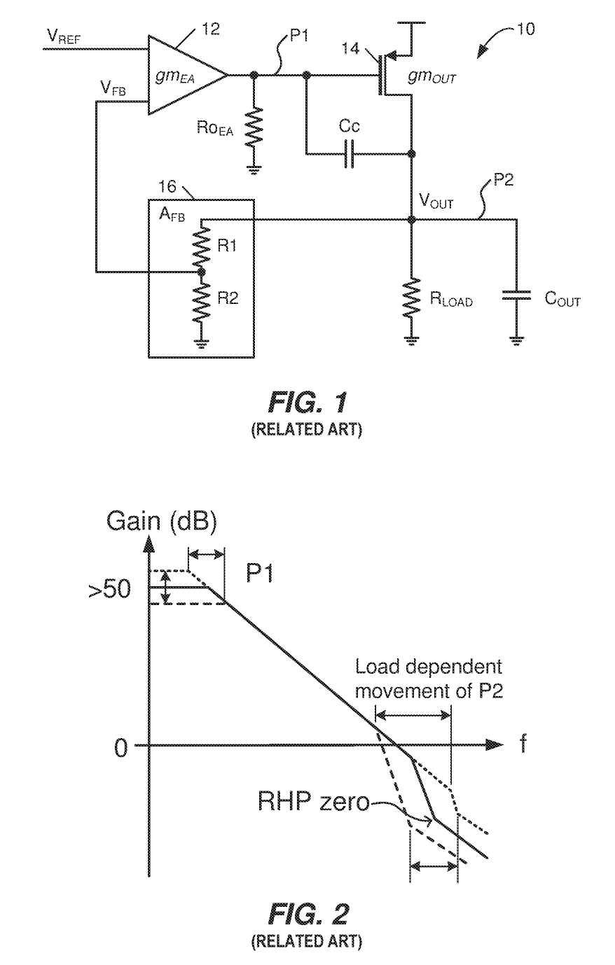

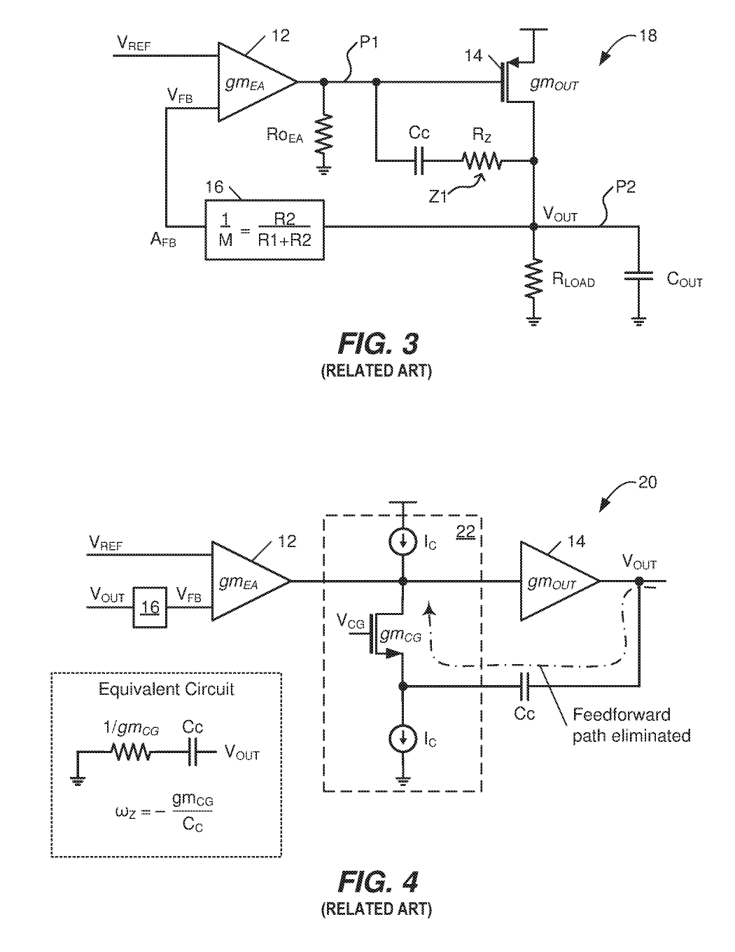

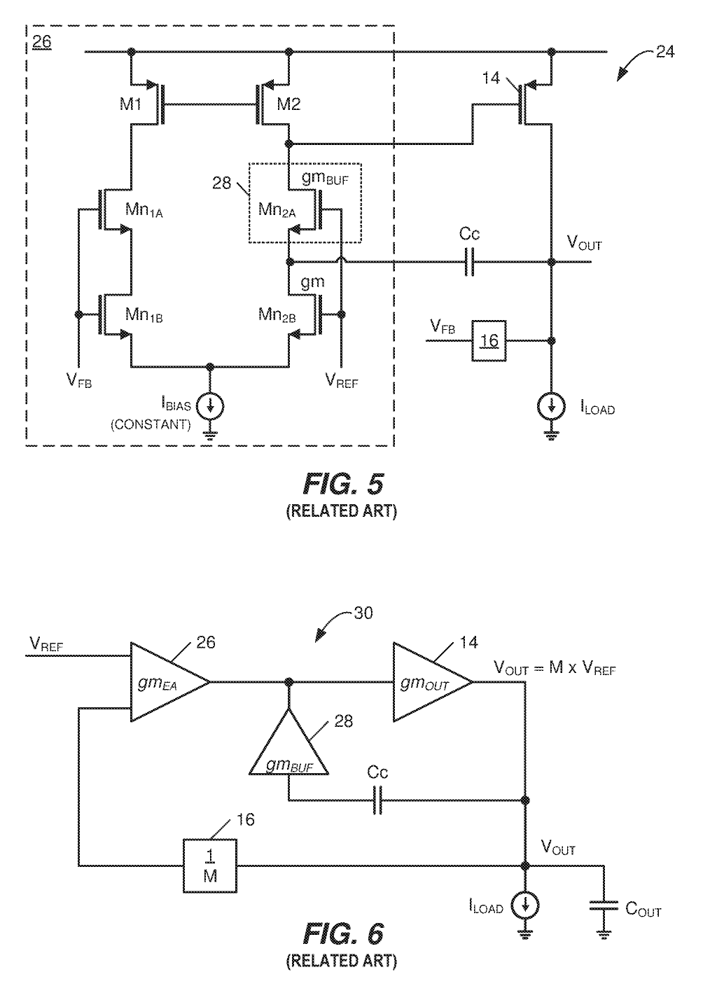

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The technique of the present disclosure is in the field of integrated power supply, specifically in design of integrated LDOs that may or may not use an external (off-chip) capacitor. A few key design requirements for such a voltage regulator are the following: (a) low power dissipation (low quiescent current), (b) fast transient response, (c) high Power Supply Rejection Ratio (PSRR) in a wide bandwidth, and (d) stability over several decades of load current. These requirements can present contrasting design challenges since, for example, fast transient response requires high quiescent current and the traditional Miller compensation approach to stabilizing an LDO leads to low overall bandwidth. The technique of the present disclosure utilizes a stabilizing circuit that allows simultaneous fulfillment of the aforementioned design goals.

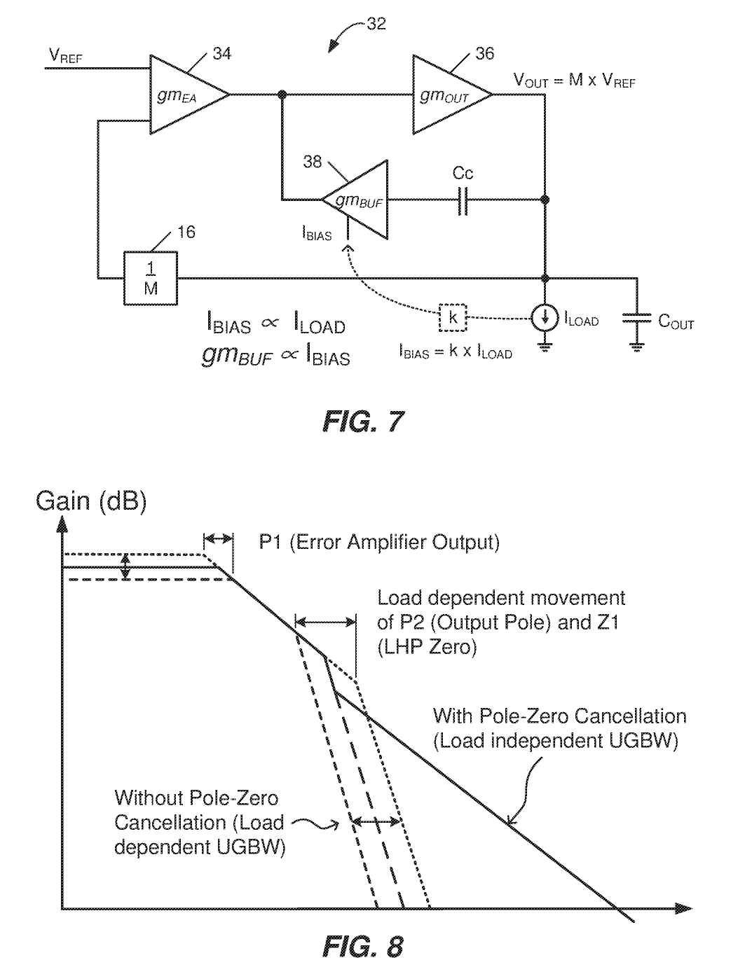

FIG. 7 is a circuit schematic illustrating an exemplary LDO voltage regulator 32 having improved compensation according to an embodiment of the present disclosure. In the embodiment illustrated in FIG. 7, the LDO 32 includes an error amplifier 34, an output amplifier 36, the voltage divider 16, and an improved buffer amplifier 38. Each amplifier drawn can consist of one or more stages.

The technique of the present disclosure improves upon the traditional indirect Miller compensation techniques by removing the bandwidth limitation of the system. This is done by implementing the buffer amplifier 38 in such a way that the transconductance of this amplifier (gm_{BUF}) is proportional to the load current. By doing so, the frequency of LHP zero introduced by the buffer amplifier 38 is directly proportional to the load current and consequently proportional to the output pole (P2). In one embodiment, gm_{BUF}, Cc, and Cout are chosen in such a way that the LHP zero and P2 are placed close to each other, resulting in a cancellation of this pole-zero combination.

FIG. 8 is a graph of the frequency response of the exemplary LDO voltage regulator 32 according to one embodiment of the present disclosure. Because the LHP zero and the output pole track each other over several decades of load current, the stability condition over load current variations is much relaxed. Further, this pole-zero cancellation implies that P1 can be chosen to be higher and the Unity Gain Bandwidth (UGBW) of the system can be significantly higher. This results in faster transient response and higher PSRR bandwidth of the LDO 32.

Typically, the gm of a transistor is directly proportional to the bias current. For a transistor in saturation mode, this can be written in the form of the following equation:

$$gm = \frac{2 * {I}_{bias}}{{V}_{gs} - {V}_{t}} \qquad EQ . [ 7 ]$$

Here, I_{bias} represents the current through the drain of the transistor and may also be referred to as I_{drain}.

In one embodiment, gm_{BUF} is designed to be proportional to the output load current. The equations for P2 and LHP_{zero} are as follows in Equations (8) and (9):

$$\begin{matrix}P 2 ≅ \frac{{I}_{LOAD}}{{V}_{out} Cc} & EQ . ( 8 ) \\ {LHP}_{zero} = - \frac{2 * {I}_{bias}}{( {V}_{gs} - {V}_{t} ) {C}_{c}} & EQ . ( 9 )\end{matrix}$$

Pole cancellation can be achieved by:

$${I}_{bias} = \frac{( {V}_{gs} - {V}_{t} )}{2 {V}_{out}} {I}_{LOAD} \qquad EQ . ( 10 )$$

This leads to the situation in which the output pole is first-order cancelled by the LHP zero introduced by the compensation buffer.

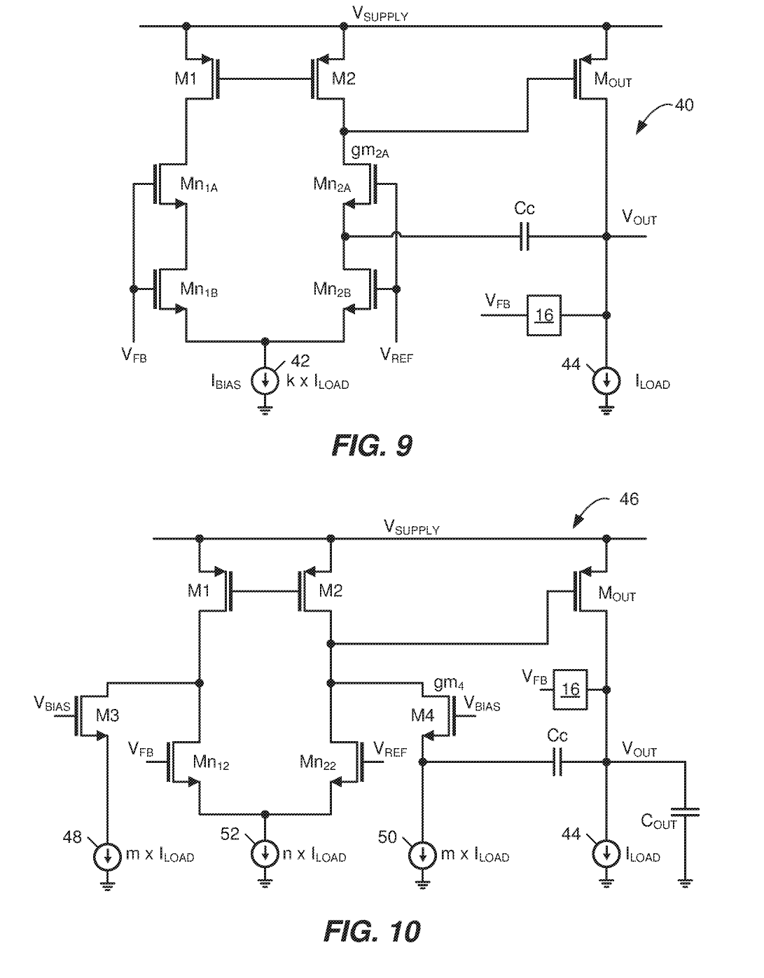

FIG. 9 is a circuit schematic showing one embodiment of the technique of the present disclosure using split-length MOS compensation. In the embodiment illustrated in FIG. 9, an LDO 40 includes an error amplifier, which comprises transistors M1, M2, Mn_{1A}, Mn_{1B}, Mn_{2A}, Mn_{2B}, and a bias current source 42. The LDO 40 also includes an output amplifier comprising a transistor M_{OUT}. The LDO 40 is Miller-compensated, with a compensation capacitor (Cc), and the LHP zero is proportional to the transconductance of Mn_{2A}(gm_{2A}). The load capacitance seen at V_{OUT} is represented by the capacitor (C_{OUT}), and the load current (I_{LOAD}) is represented by a current source 44.

In the embodiment illustrated in FIG. 9, the bias current produced by bias current source 42 is k times the load current (I_{LOAD}). In this manner, gm_{2A} can be made proportional to the load current by using a current mirror to adaptively bias the first amplifier stage. FIG. 9 illustrates a differential implementation of the gm_{BUF}, therefore, the current k*I_{LOAD} represents 2*I_{BIAS}. Therefore,

$$\begin{matrix}k = \frac{2 * {I}_{bias}}{{I}_{load}} & EQ . ( 11 ) \\ k = \frac{( {V}_{gs} - {V}_{t} )}{{V}_{out}} & EQ . ( 12 )\end{matrix}$$

Here, V_{gs} and Vₜ refer to the gate-source voltage and the threshold voltage, respectively, of transistors Mn_{2A} and Mn_{1A}. In the embodiment illustrated in FIG. 9, k=75.

FIG. 10 is a circuit schematic showing another embodiment of the present disclosure using adaptively biased cascode compensation. In the embodiment illustrated in FIG. 10, an LDO 46 includes an error amplifier, which comprises transistors M1, M2, M3, M4, Mn₁₂, Mn₂₂, and bias current sources 48, 50, and 52. The LDO 46 also includes an output amplifier comprising a transistor M_{OUT}. The LDO 46 is Miller-compensated, with a compensation capacitor (Cc). The load capacitance seen at V_{OUT} is represented by capacitor C_{OUT} and the load current I_{LOAD} is represented by a current source 44.

In the embodiment illustrated in FIG. 10, the LHP zero depends on the transconductance of M4 (gm₄), which can be made proportional to the load current I_{LOAD} by using a bias current derived from a current mirror. In the embodiment illustrated in FIG. 10, each of the bias currents produced by bias current sources 48 and 50, respectively, are m times I_{LOAD}. Additionally, the bias current of the bias current source 52 can also be made proportional to the load current, which results in better efficiency without compromising transient performance. In the embodiment illustrated in FIG. 10, the bias current produced by the bias current source 52 is n times I_{LOAD}. Additionally, in this implementation the LHP zero can be controlled independently from the dominant pole location, which allows a degree of freedom in the design.

In the embodiment illustrated in FIG. 10, the transistors labeled ‘M3’ and ‘M4’ form the gm_{BUF} stages for this implementation. Therefore, the equation derived (and repeated below) for relationship between the gm_{BUF} and I_{LOAD} would apply to these transistors

$$\begin{matrix}{I}_{bias} = \frac{( {V}_{gs} - {V}_{t} )}{2 {V}_{out}} {I}_{LOAD} & EQ . ( 13 ) \\ m = \frac{{I}_{bias}}{{I}_{LOAD}} & EQ . ( 14 ) \\ m = \frac{( {V}_{gs} - {V}_{t} )}{2 {V}_{out}} & EQ . ( 15 )\end{matrix}$$

Here V_{gs} and Vₜ apply to the gate-source voltage and threshold voltage of the transistors M3 and M4.

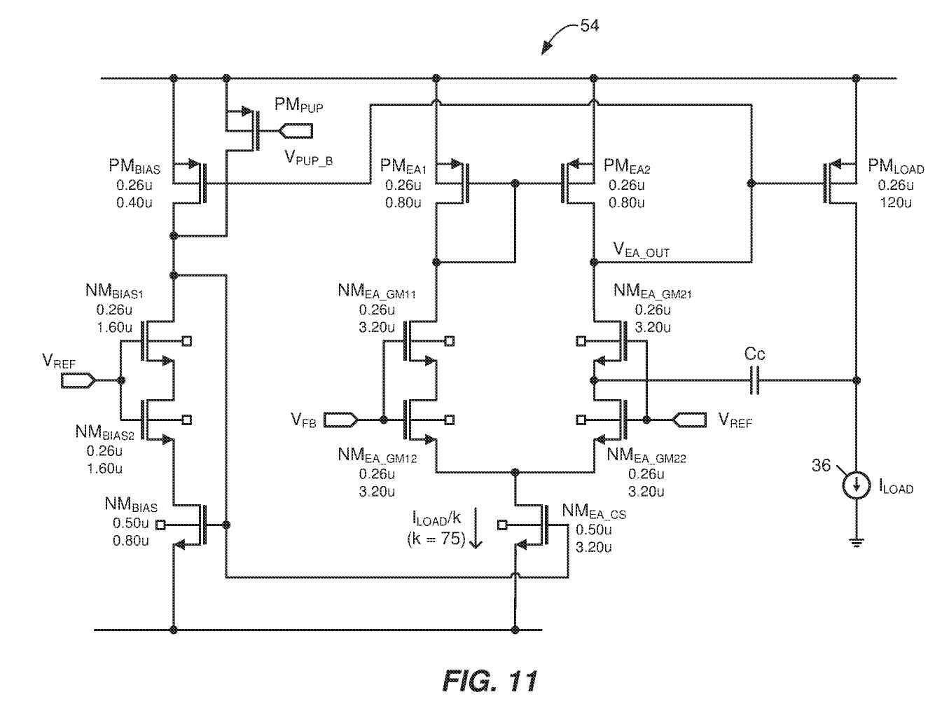

FIG. 11 is a circuit schematic showing another embodiment of the present disclosure using adaptively biased cascode compensation. In an LDO 54 illustrated in FIG. 11, the current through the output transistor (PM_{LOAD}) is mirrored through a transistor (PM_{BIAS}). The current through PM_{BIAS} is then mirrored to the current source below the differential pair of the error amplifier, NM_{EA}_{_}_{CS}. Each transistor in FIG. 11 is labeled with a name, the length of the transistor, and the width of the transistor. For example, in the embodiment illustrated in FIG. 11, the transistor (PM_{BIAS}) has a length of 0.26 μm and a width of 0.40 μm.

Thus, the current flowing through NM_{EA}_{_}_{CS} is proportional to the current through PM_{LOAD}, which is represented as current “I_{LOAD}” in FIG. 11. Specifically, in the embodiment illustrated in FIG. 11, the current through NM_{EA}_{_}_{CS} is approximately I_{LOAD}/k, where the value of “k” is 75. The subject matter described herein is not limited to just that value, however. Other values are contemplated for k, m, n, etc. The performance of an LDO voltage regulator is improved so long as gm_{BUF} is proportional to I_{LOAD} (in any proportion) when compared to the performance of an LDO voltage regulator having a gm_{BUF} that is static (i.e., not proportional to I_{LOAD}), regardless of whether the transistor is in saturation mode or in some other mode.

Those skilled in the art will recognize improvements and modifications to the present disclosure. All such improvements and modifications are considered within the scope of the concepts disclosed herein.

What is claimed is:

1. A voltage regulator for accepting an input voltage (V_{REF}) and producing an output voltage (V_{OUT}), the voltage regulator comprising:
an operational amplifier having a first input, a second input, and an output, the first input accepting the input voltage (V_{REF});
an output amplifier having an input coupled to the output of the operational amplifier and an output that produces the output voltage (V_{OUT}), the output being coupled to a feedback path that produces a feedback voltage (V_{FB}) that is applied to the second input of the operational amplifier;
a compensation capacitor (Cc) having a first terminal and a second terminal, the first terminal coupled to the output of the output amplifier; and
a buffer amplifier having an input coupled to the second terminal of the compensation capacitor (Cc), and having an output coupled directly or indirectly to the input of the output amplifier, the buffer amplifier having a transconductance (gm_{BUF}) that is controlled to be proportional to a load current (I_{LOAD}).

2. The voltage regulator of claim 1 wherein the transconductance (gm_{BUF}) is proportional to a bias current (I_{BIAS}) being supplied to the buffer amplifier and wherein the bias current (I_{BIAS}) being supplied to the buffer amplifier is proportional to the load current (I_{LOAD}).

3. The voltage regulator of claim 1 wherein the operational amplifier introduces a first pole (P1), wherein the output amplifier introduces a second pole (P2), wherein the buffer amplifier introduces a Left Hand Plane (LHP) zero (LHP_{ZERO}), and wherein the transconductance (gm_{BUF}) is controlled such that the LHP zero (LHP_{ZERO}) cancels the second pole (P2).

4. The voltage regulator of claim 3 wherein
$${gm}_{BUF} = \frac{2 * {I}_{bias}}{{V}_{gs} - {V}_{t}}$$
and wherein a bias current (I_{BIAS}) is controlled such that the LHP zero (LHP_{ZERO}) cancels the second pole (P2).

5. The voltage regulator of claim 4 wherein a bias current (I_{BIAS}) is provided according to the equation
$${I}_{bias} = \frac{( {V}_{gs} - {V}_{t} )}{2 {V}_{out}} {I}_{LOAD} .$$

6. A voltage regulator for accepting an input voltage (V_{REF}) and producing an output voltage (V_{OUT}), the voltage regulator comprising:
a first P-Type Metal Oxide Semiconductor (PMOS) transistor (M1) having a source, drain, and gate, the source being coupled to a first supply (V_{SUPPLY});
a second PMOS transistor (M2) having a source, drain, and gate, the source coupled to the first supply (V_{SUPPLY}) and the gate being coupled to the gate of the first PMOS transistor (M1);
a first current source having a first terminal and a second terminal, the second terminal being coupled to ground, the first current source providing a bias current I_{BIAS};
a first N-Type Metal Oxide Semiconductor (NMOS) transistor (Mn_{1A}) having a source, drain, and gate, the drain being coupled to the drain of the first PMOS transistor (M1) and the gate being provided with a voltage (V_{FB});
a second NMOS transistor (Mn_{1B}) having a source, drain, and gate, the drain being coupled to the source of the first NMOS transistor (Mn_{1A}), the gate being provided with the voltage (V_{FB}), and the source being coupled to the first terminal of the first current source;
a third NMOS transistor (Mn_{2A}) having a source, drain, and gate, the drain being coupled to the drain of the second PMOS transistor (M2) and the gate being provided with the voltage (V_{REF});
a fourth NMOS transistor (Mn_{2B}) having a source, drain, and gate, the drain being coupled to the source of the third NMOS transistor (Mn_{2A}), the gate being provided with the voltage (V_{REF}), and the source being coupled to the first terminal of the first current source;
a third PMOS transistor (M_{OUT}) having a source, drain, and gate, the source being coupled to the first supply (V_{SUPPLY}), the gate being coupled to the drain of the second PMOS transistor (M2), and the drain being coupled to an output terminal for producing the output voltage (V_{OUT});
a second current source having a first terminal and a second terminal, the first terminal being coupled to the output terminal and the second terminal being coupled to ground, the second current source providing a load current (I_{LOAD});
a compensation capacitor (Cc) having a first terminal being coupled to the output terminal and a second terminal being coupled to the drain of the fourth NMOS transistor (Mn_{2B});
a feedback circuit having an input terminal coupled to the output terminal and an output terminal that produces the voltage (V_{FB});
wherein the bias current (I_{BIAS}) is proportional to the load current (I_{LOAD}).

7. The voltage regulator of claim 6 wherein
$${I}_{bias} = \frac{( {V}_{gs} - {V}_{t} )}{2 {V}_{out}} {I}_{LOAD}$$
wherein V_{gs} is a gate-source voltage of the third NMOS transistor (Mn_{2A}) and Vₜ is a threshold voltage of the third NMOS transistor (Mn_{2A}).

8. The voltage regulator of claim 6 wherein the bias current (I_{BIAS}) is proportional to the load current (I_{LOAD}) according to the equation
I_{bias}=k*I_{LOAD}.

9. The voltage regulator of claim 8 wherein
$$k = \frac{2 * {I}_{bias}}{{I}_{load}} .$$

10. The voltage regulator of claim 8 wherein
$$k = \frac{( {V}_{gs} - {V}_{t} )}{{V}_{out}}$$
wherein V_{gs} is the gate-source voltage of the third NMOS transistor (Mn_{2A}) and Vₜ is the threshold voltage of the third NMOS transistor (Mn_{2A}).

11. A voltage regulator for accepting an input voltage (V_{REF}) and producing an output voltage (V_{OUT}), the voltage regulator comprising:
a first P-Type Metal Oxide Semiconductor (PMOS) transistor (M1) having a source, drain, and gate, the source being coupled to a first supply (V_{SUPPLY});
a second PMOS transistor (M2) having a source, drain, and gate, the source coupled to the first supply (V_{SUPPLY}) and the gate being coupled to the gate of the first PMOS transistor (M1);
a first current source having a first terminal and a second terminal, the second terminal being coupled to ground;
a first N-Type Metal Oxide Semiconductor (NMOS) transistor (M3) having a source, drain, and gate, the drain being coupled to the drain of the first PMOS transistor (M1) and the gate being provided with a voltage (V_{BIAS});
a second NMOS transistor (M4) having a source, drain, and gate, the drain being coupled to the drain of the second PMOS transistor (M2) and the gate being provided with the voltage (V_{BIAS});
a third NMOS transistor (Mn₁₂) having a source, drain, and gate, the drain being coupled to the drain of the first PMOS transistor (M1), the gate being provided with a voltage (V_{FB}), and the source being coupled to the first terminal of the first current source;
a fourth NMOS transistor (Mn₂₂) having a source, drain, and gate, the drain being coupled to the drain of the second PMOS transistor (M2), the gate being provided with the voltage V_{REF}, and the source being coupled to the first terminal of the first current source;
a second current source having a first terminal and a second terminal, the first terminal being coupled to the source of the first NMOS transistor (M3) and the second terminal being coupled to ground;
a third current source having a first terminal and a second terminal, the first terminal being coupled to the source of the second NMOS transistor (M4) and the second terminal being coupled to ground;
a third PMOS transistor (M_{OUT}) having a source, drain, and gate, the source being coupled to the first supply (V_{SUPPLY}), the gate being coupled to the drain of the second PMOS transistor (M2), and the drain being coupled to an output terminal for producing the output voltage (V_{OUT});
a fourth current source having a first terminal and a second terminal, the first terminal being coupled to the output terminal and the second terminal being coupled to ground, the fourth current source providing a load current (I_{LOAD});
a compensation capacitor (Cc) having a first terminal being coupled to the output terminal and a second terminal being coupled to the drain of Mn_{2B};
a feedback circuit having an input terminal coupled to the output terminal and an output terminal that produces the voltage (V_{FB});
wherein the current produced by each of the first, second, and third current sources is proportional to the load current (I_{LOAD}).

12. The voltage regulator of claim 11 wherein a current produced by the second current source is m*I_{LOAD}, and a current produced by the third current source is m*I_{LOAD}.

13. The voltage regulator of claim 12 wherein
$$m = \frac{( {V}_{gs 1} - {V}_{t 1} )}{2 {V}_{out}}$$
wherein V_{gs1} is a gate-source voltage of the first and second NMOS transistors (M3 and M4) and Vₜ₁ is a threshold voltage of the first and second NMOS transistors (M3 and M4).

14. The voltage regulator of claim 12 wherein a current produced by the first current source is n*I_{LOAD}, wherein n is different from m.

15. The voltage regulator of claim 14 wherein
$$n = \frac{( {V}_{gs 2} - {V}_{t 2} )}{{V}_{out}}$$
wherein V_{gs2} is a gate-source voltage of the third and fourth NMOS transistors (Mn₁₂ and Mn₂₂) and V₁ is a threshold voltage of the third and fourth NMOS transistors (Mn₁₂ and Mn₂₂).
